(19) United States
(12) Patent Application Publication
(10) Pub. No.: US 2008/0309427 A1
(43) Pub. Date: Dec. 18, 2008

(54) Transit Structure of Standard Waveguide and Dielectric Waveguide

(75) Inventors: Bong-Su Kim, Daejon (KR); Kwang-Seon Kim, Daejon (KR); Woo-Jin Byun, Daejon (KR); Ki-Chan Eun, Daejon (KR); Myung-Sun Song, Daejon (KR)

Correspondence Address: RABIN & Berdo, PC, 1101 14TH STREET, NW, SUITE 500, WASHINGTON, DC, 20005, US

(73) Assignee: Electronics and Telecommunications Research Institute, Daejon (KR)

(21) Appl. No.: 12/096,597

(22) PCT Filed: Aug. 31, 2006
(86) PCT No.: PCT/KR2006/003460

§ 371 Date: Jun. 6, 2008

(30) Foreign Application Priority Data
Dec. 8, 2005 (KR) 10-2005-0119591
Apr. 19, 2006 (KR) 10-2006-0035298

(51) Int. Cl. H01P 5/00

(52) U.S. Cl. 333/33

(57) ABSTRACT

A transit structure of a standard waveguide and a dielectric waveguide is related to connecting the dielectric dielectric waveguide to the standard waveguide. The transit structure includes: a cavity to match the dielectric waveguide and the standard waveguide, wherein the dielectric waveguide and the standard waveguide are orthogonal to each other to connect. The transit structure drastically reduces a design time by simply implementing a transit structure by using only a dielectric waveguide, a cavity and a standard waveguide on a dielectric substrate and remarkably reduces a size thereof in comparison with a conventional transit structure since all designs are finished in the size of a metal waveguide.

### TECHNICAL FIELD

The present invention relates to a transit structure of a standard waveguide and a dielectric waveguide; and, more particularly, to a transit structure to implement a matching (impedance matching) with a simple structure when a dielectric waveguide is connected to a standard waveguide.

### BACKGROUND ART

Wireless communication in a knowledge information era is expected to be developed from a second generation based on a sound and a text and a third generation mobile communication of an image information transmission IMT2000 to a fourth generation system having a transmission speed larger than 100 Mbps. In the fourth generation system having such broad bandwidth, there is required for developing a new frequency in place of a conventional frequency bandwidth previously saturated, and it is very important to applying a millimeter bandwidth as a frequency to realize such broad bandwidth and high-speed communication.

However, since the communication system of a millimeter wave bandwidth is expensive and bulky by being constructed with a plurality of individual devices, they act as shortcomings in commercializing this bandwidth. In order to overcome these shortcomings and to use as RF components, many studies have been developed for miniaturization, device having a low cost and a low loss, and a packaging technology.

Particularly, in case that a system in s package (SiP) technology employs a low temperature Co-fired ceramics (LTCC), they have been proposed in various types such as a point to multi-points communication transceiver with 26 GHz bandwidth, a short range wireless communication system with 60 GHz and 70 GHz bandwidths.

In such millimeter wave system, various types of transit structures are used for connecting the transmitters or the receivers to the antennas.

Generally, a conventional transit structure is a micro strip line or a transit structure of a strip line and a waveguide by using a single layer substrate technology. And, it is general that a rear side cavity shape is required through a fabrication of a mechanical structure.

And, recently a transit structure using a stack process appears; this is a structure using a dielectric cavity and an aperture with a lowest surface as a dielectric waveguide and a waveguide. By such conventional technology, there are several shortcomings in realizing a structure having an optimum performance due to a complex matching structure and dielectric resonator and very many parameters of the aperture.

### DISCLOSURE

### Technical Problem

The present invention has been proposed in order to overcome the above-described problems in the related art. A dielectric waveguide and a standard waveguide are placed in an orthogonal direction and a matching is implemented by providing a simple structure with a cavity for a matching between the dielectric waveguide and the standard waveguide. It is, therefore, an object of the present invention to provide a transit structure to reduce a size thereof and shortening a design time thereof.

It is another object of the present invention to provide a transit structure of a standard waveguide and a dielectric waveguide capable of easily compensating a frequency and matching error generated at a practical manufacturing by varying an impedance characteristic of the dielectric waveguide by allowing a degree of insertion to be changed in inserting a tuning rod into the dielectric waveguide.

In order to achieve the above-described objects, the present invention is a transit structure generally including 3 types of a dielectric waveguide, a cavity and a standard waveguide, wherein the cavity is placed between the dielectric waveguide and the standard waveguide.

### Technical Solution

In accordance with an aspect of the present invention, there is provided a transit structure of a standard waveguide and a dielectric waveguide is characterized in that: the dielectric waveguide is positioned in a direction orthogonal to the standard waveguide to connect the dielectric waveguide to the standard waveguide; and the transit structure includes a cavity to match between the dielectric waveguide and the standard waveguide.

In accordance with another aspect of the present invention, there is provided a transit structure for connecting a standard waveguide to a dielectric waveguide, the transit structure including: a cavity to match the dielectric waveguide and the standard waveguide, wherein the dielectric waveguide and the standard waveguide are orthogonal to each other to connect.

It is preferable that the dielectric waveguide includes: a first ground surface existing at a top surface of the dielectric waveguide; a second ground surface existing at a bottom surface of the dielectric waveguide which a pattern is removed at a portion connected to the cavity is removed; a dielectric substrate is placed between the first ground surface and the second ground surface to form the dielectric waveguide; and a plurality of bias arranged in at least one column connected to the first ground surface and the second ground surface to form a wall of the dielectric waveguide.

It is preferable that if the plurality of bias is arranged in at least two columns, the bias of a front column and the bias of a rear column are placed with crossing each other.

It is preferable that wherein the dielectric waveguide is made of many folded dielectric substrates and a top via and a bottom via are connected by a pattern.

It is preferable that the cavity is formed by removing a portion of the dielectric substrate placed between a top of a second ground surface where a pattern of a cavity portion is removed and a bottom of a third ground surface where a pattern of the cavity portion is removed, and a cavity wall is formed by a plurality of bias arranged in at least one column to connect the second ground surface to the third ground surface.

It is preferable that if the bias is arranged in at least two columns, the bias of a front column and the bias of a rear column are placed with crossing each other.

It is preferable that the dielectric waveguide is made of many folded dielectric substrates and a top via and a bottom via are connected by a pattern.

It is preferable that the dielectric waveguide allows a tuning rod to be inserted and is capable of controlling a degree of the insertion of the tuning rod.

It is preferable that the insertion of tuning rod is performed by inserting the tuning rod into a hole to face a cavity connection unit on the dielectric waveguide.

It is preferable that the transit structure further includes: a dielectric substrate formed on a dielectric waveguide; and a most upper ground surface, wherein the plurality of holes to insert the tuning rod is formed on the upper most ground surface and the dielectric substrate.

### ADVANTAGEOUS EFFECTS

The present invention can drastically reduce a design time by simply implementing a transit structure by using only a dielectric waveguide, a cavity and a standard waveguide on a dielectric substrate and remarkably reduce a size thereof in comparison with a conventional transit structure since all designs are finished in the size of a metal waveguide.

### DESCRIPTION OF DRAWINGS

The above and other objects and features of the present invention will become apparent from the following description of the preferred embodiments given in conjunction with the accompanying drawings, in which:

FIG. 1 is a concept diagram showing a transit structure of a standard waveguide and a dielectric waveguide in accordance with one embodiment of the present invention;

FIG. 2 is a plan view of FIG. 1;

FIG. 3 is a cross-sectional view of FIG. 1;

FIG. 4 is a three-dimensional exploded perspective view in accordance with one embodiment of the present invention;

FIG. 5 is a cross-sectional diagram of the transit structure of FIG. 4; and

FIG. 6 and FIG. 7 are performance graphs of the transit structure of the standard waveguide and the dielectric waveguide.

### BEST MODE FOR THE INVENTION

Hereinafter, preferred embodiments of the present invention are described in detail with respect to the accompanying drawings in such a manner that it may easily be carried out by a person having ordinary skilled in the art to which the invention pertains.

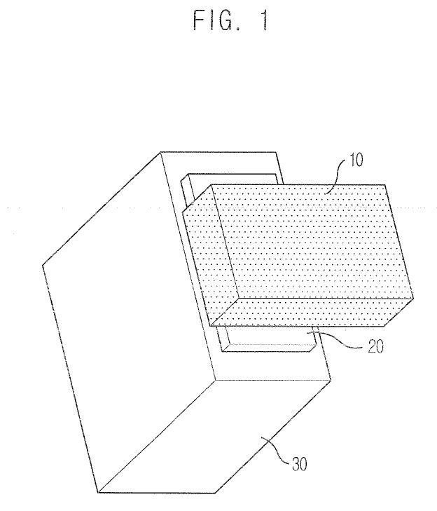

FIG. 1 is a concept diagram showing a transit structure of a standard waveguide and a dielectric waveguide in accordance with one embodiment of the present invention.

As shown in FIG. 1, an overall transit structure includes 3 types of elements, i.e., a dielectric waveguide 10, a cavity 20 and a standard waveguide 30. Sizes of the dielectric waveguide 10 and the standard waveguide 30 are generally determined by a frequency of an overall system and a structure of a transceiver or the like, and a width and a height of the cavity 20 positioned between the dielectric waveguide 10 and the standard waveguide 30 become important factors to determine a performance of the transit structure.

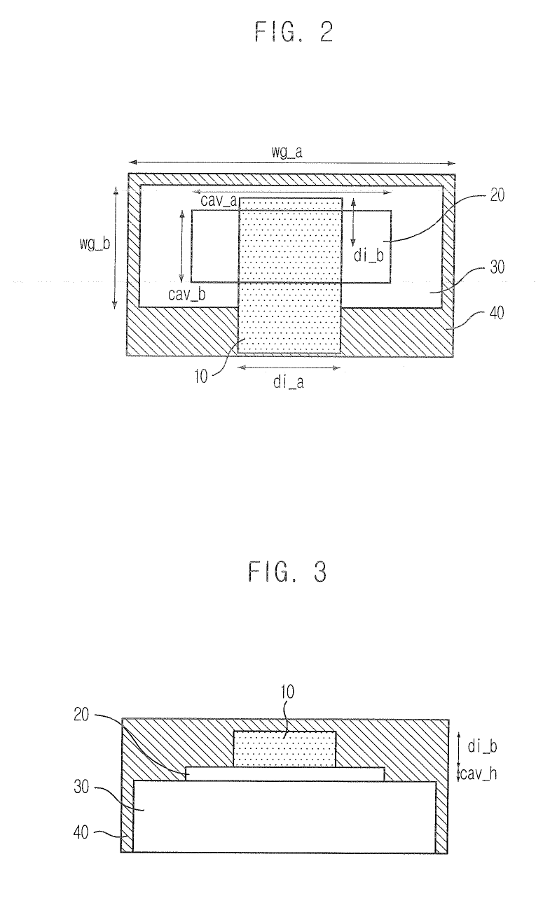

FIG. 2 and FIG. 3 are a plan view and a cross-sectional view of FIG. 1, respectively.

The sizes wg_a and wg_b of the standard waveguide 30 shown in FIG. 2 are parameters, which are previously determined by a use frequency of the system. For example, in case of a WR-22 standard rectangular waveguide, wg_a×wg_b=5.8 mm×2.9 mm.

And also, in order to design the dielectric waveguide based on the standard waveguide filling an inside thereof with an air, overall sizes of the designed waveguide must be constantly reduced by a ratio of 1/\sqrt{∈ᵣ} in all directions of x, y and z in the air according to the change of the dielectric constant as shown in the following mathematical equation (1).

λ_{g}=2π/β=2π\sqrt{k²=k_{c}²} Eq. (1)

Wherein, in the equation (1), k=ω\sqrt{μ∈}, k_{c}=\sqrt{(mπ/a)²+(nπ/b)²} and λ_{g} is a wavelength of the waveguide, β is a propagation constant, κ is a frequency of material, κ_{c} is a blocking wave number (a is a length of a longitudinal axis and b is a length of a vertical axis).

Since, in a high frequency in the order of a millimeter, a relation of k>>k_{c} exists, it is noted that g is in inversely proportional to \sqrt{∈ᵣ} through a simplification. And also, since a waveguide filter utilizes TE10 mode, z-axis, i.e., the height nearly affect to the performance except a slight increment of a loss.

That is, in case when a dielectric constant of 7.1 is used, the size of WR-22 standard waveguide is 5.8 mm×2.9 mm, whereas the size of the dielectric waveguide becomes to change into 5.8/\sqrt{7.1}=2.18 mm×2.9/\sqrt{7.1}=1.09 mm.

In FIG. 2, a length di_1 from a center of the cavity 20 to an end of the dielectric waveguide 10 is a very important parameter to determine the transit frequency and the sizes cav_a and cav_b of the cavity 20 play roles of matching the dielectric waveguide 10 with the standard waveguide 30, whereby the most of overall performance are determined by those.

In FIG. 3, a height di_h of the dielectric waveguide 10 and a height cav_h of the cavity 20 are shown. Herein, the height of the dielectric waveguide 20 does not greatly affect to the performance as described above when the dielectric waveguide 20 is operated as a waveguide, but it becomes a major parameter to control the frequency and to control the matching when the transit structure is designed. And, the height cav_h of the cavity 20 is a major parameter to perform the matching together with the widths cav_a and cav_b of the cavity 20.

Therefore, the transit structure in accordance with the present invention determines the performance thereof according to the height di_h and the width di_1 of the dielectric waveguide 10 and the widths cav_a and cav_b of the cavity, since the height of the dielectric waveguide 10 and the heights of the cavity 20 among those depend on a previously determined height of the multi-layered substrate (and also, it is possible that a height is controlled by folding various sheets, but a continuous changed is difficult), in this result, the performance of the waveguide transit structure in accordance with the present invention is determined according to the length of the dielectric waveguide 10 and the cavity 20.

FIG. 4 is a three-dimensional exploded perspective view in accordance with one embodiment of the present invention.

FIG. 4 shows a structure that a dielectric substrate 12 forming the dielectric waveguide 14 has a first ground surface 11 and a second ground surface 13 and the first ground surface 11 and the second ground surface 13 are connected through a plurality of bias 14. The plurality of bias 14 can be at least one column to form a wall of the dielectric waveguide 16, since it prevent a signal from discharging if two columns of the bias are placed with crossing each other as shown in the drawings, the performance of the dielectric waveguide 16 is further improved. And, in the second ground surface 13, a pattern formed on a surface adjacent to the cavity 25 is removed (referring to a reference numeral 15).

The cavity 25 is formed by removing a portion of the dielectric substrate 21 and the second ground surface 13 formed on a top of the dielectric substrate 21 and a third ground surface 22 formed on a bottom of the dielectric substrate 21 are connected through the bias 23, the bias 23 are positioned with maximally accessing to the sidewall of the cavity 25 to form a complete cavity 25. And also, at least one column of the bias 23 can be used similar to the case of the dielectric waveguide. Similar to the second ground surface 13, a pattern is removed at a portion contacting to the cavity 25 is removed (referring to a reference numeral 24).

The standard waveguide 31 is placed below the cavity 25. Herein, the standard waveguide 31 is generally made of metal, but it can give the similar effect that of the metal by coating a metal component on a surface of a general dielectric material. Therefore, the present invention is not limited to the metal.

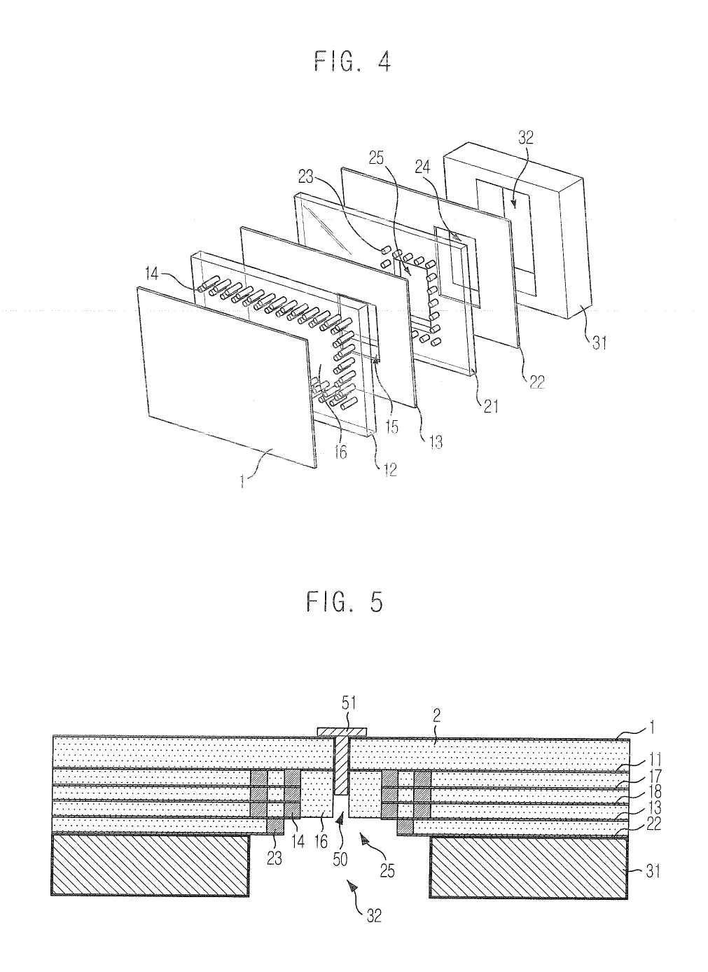

FIG. 5 is a cross-sectional diagram applying of the transit structure of the present invention to a practical circuit board as a drawing of a cross-sectional diagram of a transit structure shown in FIG. 4 to represent a structure having a tuning rod. As shown in the drawing, the first ground surface 11 and the second ground surface 13 for the circuit substrate 2 and the dielectric waveguide 16 placed in the module are formed inside of the multi-layered substrate. A plurality of layers can be formed between the first ground surface 11 and the second ground surface 13. In this case, the plurality of bias 14 are formed in each layer to connect the first ground surface 11 and the second ground surface 13 and a plurality of patterns 17 and 18 are formed to connect the plurality of bias 14. And, a hole 50 is formed to insert the tuning rod 51 from the most upper ground surface 1 to the dielectric waveguide 16. And also, the second ground surface 13 and the third ground surface 22 are formed on a bottom portion of the dielectric waveguide 16 to construct the cavity 25 and a plurality of layers can be formed between the second ground surface 13 and the third ground surface 22 similar to that of the dielectric waveguide 16. And, a plurality of bias 23 is formed along a plurality of wall surfaces of the cavity 25 to connect the plurality of layers.

Finally, a standard waveguide 31 is placed on the third ground surface 23 and is formed to be connected to a device having an external waveguide interface such as an external filter and an antenna or the like.

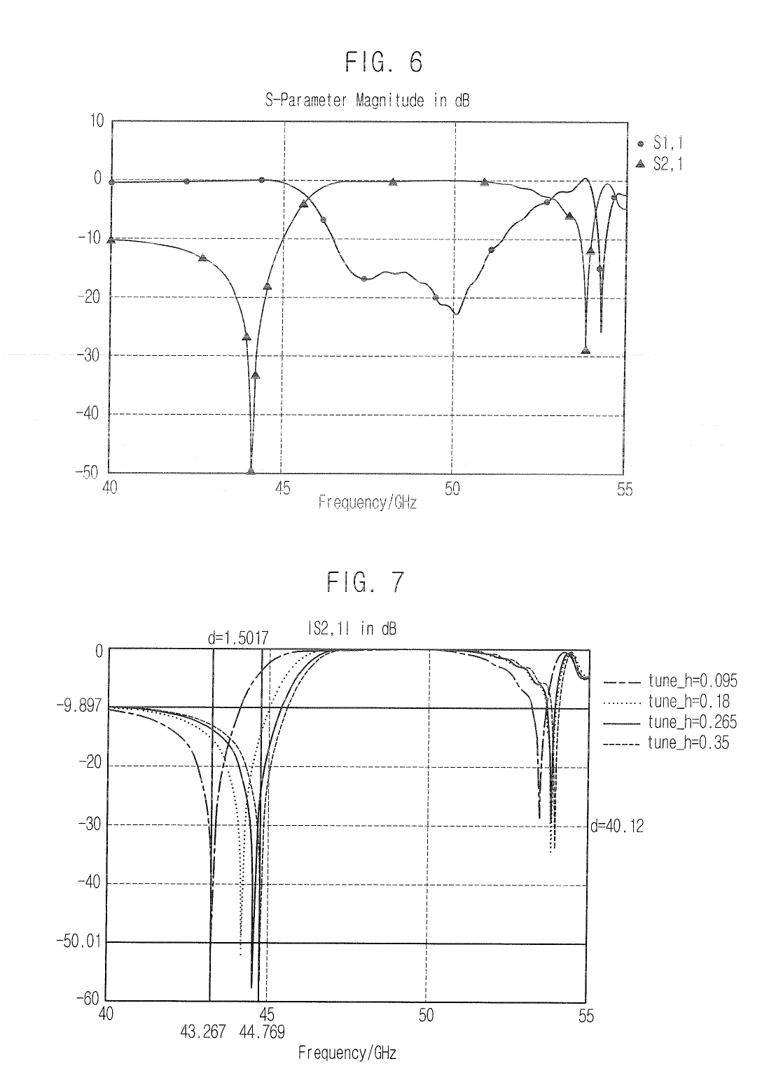

FIG. 6 and FIG. 7 are a performance graph of the transit structure of the standard waveguide and the dielectric waveguide.

FIG. 6 is a simulation result of the transit structure in accordance with one embodiment of the present invention, and FIG. 7 is a simulation result that obtained by inserting the tuning rod into the transit structure in accordance with the present invention with controlling the tuning rod up and down.

As shown in FIG. 6 and FIG. 7, in accordance with one embodiment of the present invention, changing impedance according to controlling the position of the tuning rod can vary a frequency and a matching.

While the present invention has been described with respect to certain preferred embodiments, it will be apparent to those skilled in the art that various changes and modifications may be made without departing from the scope of the invention as defined in the following claims.

What is claimed is:

1. A transit structure for connecting a standard waveguide to a dielectric waveguide, the transit structure comprising:
a cavity for matching the dielectric waveguide and the standard waveguide, wherein the dielectric waveguide and the standard waveguide are orthogonal to each other to connect.

2. The transit structure as recited in claim 1, wherein the dielectric waveguide includes:
a first ground surface existing at a top surface of the dielectric waveguide;
a second ground surface existing at a bottom surface of the dielectric waveguide which a pattern is removed at a portion connected to the cavity is removed;
a dielectric substrate is placed between the first ground surface and the second ground surface to form the dielectric waveguide; and
a plurality of bias arranged in at least one column connected to the first ground surface and the second ground surface to form a wall of the dielectric waveguide.

3. The transit structure as recited in claim 2, wherein if the plurality of bias are arranged in at least two columns, the bias of a front column and the bias of a rear column are placed with crossing each other.

4. The transit structure as recited in claim 3, wherein the dielectric waveguide is made of many folded dielectric substrates and a top via and a bottom via are connected by a pattern.

5. The transit structure as recited in claim 1, wherein the cavity is formed by removing a portion of the dielectric substrate placed between a top of a second ground surface where a pattern of a cavity portion is removed and a bottom of a third ground surface where a pattern of the cavity portion is removed, and a cavity wall is formed by a plurality of bias arranged in at least one column to connect the second ground surface to the third ground surface.

6. The transit structure as recited in claim 5, wherein if the bias are arranged in at least two columns, the bias of a front column and the bias of a rear column are placed with crossing each other.

7. The transit structure as recited in claim 5, wherein the dielectric waveguide is made of many folded dielectric substrates and a top via and a bottom via are connected by a pattern.

8. The transit structure as recited in claim 1, wherein the dielectric waveguide allows a tuning rod to be inserted and is capable of controlling a degree of the insertion of the tuning rod.

9. The transit structure as recited in claim 8, wherein the insertion of tuning rod is performed by inserting the tuning rod into a hole to face a cavity connection unit on the dielectric waveguide.

10. The transit structure as recited in claim 9, further includes:
a dielectric substrate formed on a dielectric waveguide; and
a most upper ground surface,
wherein the plurality of holes to insert the tuning rod is formed on the upper most ground surface and the dielectric substrate.
